(19) United States
(12) Patent Application Publication
(10) Pub. No.: US 2014/0240262 A1
(43) Pub. Date: Aug. 28, 2014

(54) APPARATUS AND METHOD FOR SUPPORTING VOICE SERVICE IN A PORTABLE TERMINAL FOR VISUALLY DISABLED PEOPLE

(71) Applicant: Samsung Electronics Co., Ltd., Gyeonggi-do (KR)

(72) Inventor: Debashish PAUL, Bangladesh (BD)

(73) Assignee: Samsung Electronics Co., Ltd., Gyeonggi-do (KR)

(21) Appl. No.: 14/191,770

(22) Filed: Feb. 27, 2014

(30) Foreign Application Priority Data
Feb. 27, 2013 (KR) 10-2013-0020862

(51) Int. Cl. G06F 3/041

(52) U.S. Cl. CPC G06F 3/0412
USPC 345/173

(57) ABSTRACT

A method is provided including outputting, by a communications terminal, a first voice message identifying a first screen that is displayed on a touchscreen of the communications terminal; and executing a command in response to a touch input being received at the touchscreen.

### CLAIM OF PRIORITY

This application claims the benefit under 35 U.S.C. §119(a) of a Korean patent application filed on Feb. 27, 2013 in the Korean Intellectual Property Office and assigned Serial No. 10-2013-0020862, the entire disclosure of which is hereby incorporated by reference.

### TECHNICAL FIELD

The present disclosure relates generally to telecommunications, and more particularly, to an apparatus and a method for supporting a voice service in a portable terminal for visually disabled people.

### BACKGROUND

Portable terminals, such as smart phones, provide various specialized functions intended to assist people with impaired vision. Many such functions, however, do not permit sufficient freedom of interaction. Accordingly, the need exists for new services and User Experiences (UX) that enable the visually impaired to take advantage of the full set of functions that are available on portable terminals.

### SUMMARY

The present disclosure addresses this need. According to one aspect of the disclosure, a method is provided comprising outputting, by a communications terminal, a first voice message identifying a first screen that is displayed on a touchscreen of the communications terminal; and executing a command in response to a touch input being received at the touch screen.

According to another aspect of the disclosure, an apparatus is provided comprising: a touchscreen; and a controller configured to: output a first voice message identifying a first screen that is displayed on the touchscreen; and execute a command in response to a touch input being received at the touchscreen.

### BRIEF DESCRIPTION OF THE DRAWINGS

The above features and advantages of the disclosure will be more apparent from the following detailed description in conjunction with the accompanying drawings, in which:

FIG. 1 is a block diagram illustrating an example of a configuration of an electronic device 100 according to an aspect of the present disclosure.

FIG. 2 is a flowchart of an example of a process, according to aspects of the present disclosure.

FIG. 3 is a diagram of an example of an interface for activating the special assist mode in a communications terminal.

FIG. 4 is a diagram of an example of a user interface according to aspects of the disclosure.

FIG. 5 is a diagram of an example of another user interface according to aspects of the disclosure.

FIG. 6 is a diagram of an example of yet another user interface according to aspects of the disclosure.

FIG. 7 is a diagram of an example of yet another user interface according to aspects of the disclosure.

FIG. 8 is a diagram of an example of yet another user interface according to aspects of the disclosure.

### DETAILED DESCRIPTION

Aspects of the disclosure are described with reference to the accompanying drawings in detail. The same reference numbers are used throughout the drawings to refer to the same or like parts. Detailed descriptions of well-known functions and structures incorporated herein may be omitted to avoid obscuring subject matter that is considered more pertinent.

In the present disclosure, the term “special assist mode” refers to a mode of operation of an electronic device in which the electronic device is configured to output audible messages identifying on or more characteristics of displayed screens or objects that are part of those screens. The term “special assist gesture” refers to a touch gesture which triggers a specific action only when the electronic device is the special assist mode.

According to aspects of the present disclosure, an apparatus having a touch screen provides a voice service function. Additionally or alternatively, in some implementations, the apparatus may provide a voice output function corresponding to screen layout information to image the screen output on the display unit as well as screen operation information according to the user operation. Additionally or alternatively, in some implementations, the apparatus may support touch gestures optimized for visually impaired people.

The techniques described in the present disclosure may be implemented in any electronic device that includes a Graphical User Interface (GUI). For example, the techniques may be implemented in a communications terminal, such as a mobile phone, a smart phone, a tablet PC, a hand-held PC, a Portable Multimedia Player (PMP), and a Personal Digital Assistant (PDA), a desktop computer, and/or any other suitable type of electronic device.

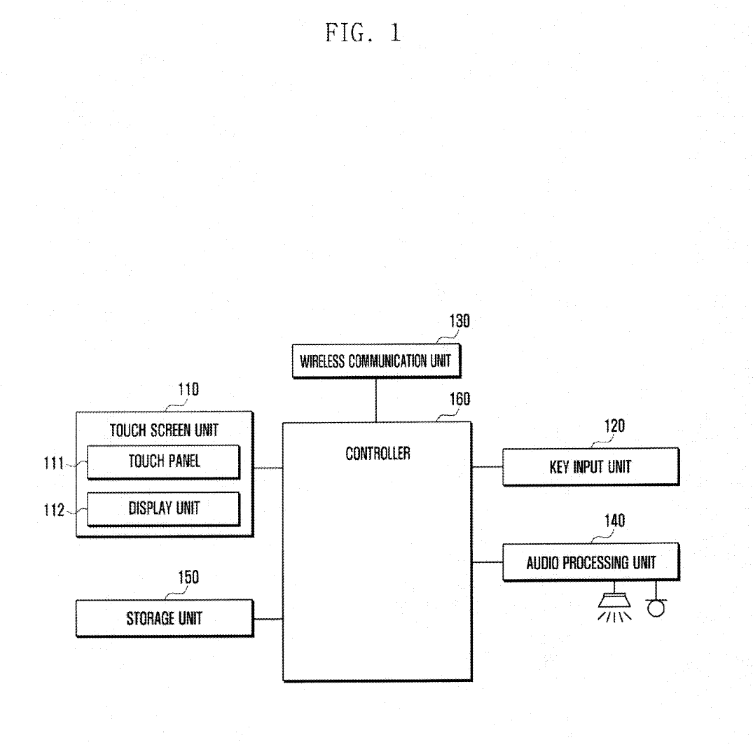

FIG. 1 is a block diagram illustrating an example of a configuration of an electronic device 100 according to an aspect of the present disclosure. Although in this example, the electronic device is a portable terminal, in other examples, it may be any other suitable type of electronic device, such as a desktop computer, a laptop, a gaming console, a home entertainment device, for instance. The portable terminal 100, according to aspects of the present disclosure, may include a touch screen 110 configured with a touch panel 111 and a display unit 112, a key input unit 120, a wireless communication unit 130, an audio processing unit 140, a storage unit 150, and a controller 160.

The touch screen 110 may display a screen according to a user function execution, and may detect a touch event related to a user function control. The touch panel 111 is placed on the display unit. In particular, the touch panel 111 may be implemented as an add-on type positioned in front of the display unit 112, or an on-cell type or an in-cell type that is inserted into the display unit 112. A size of the touch screen 110 may be determined as a size of the touch panel 111. The touch panel 111 may generate an analog signal (e.g., a touch event) in response to a user input information (e.g., a user gesture) corresponding to the touch panel 111, and may deliver the signal to the controller 160 by performing an analog to a digital conversion of the analog signal. Here, the touch event may include touch coordinate (X, Y) information.

The controller 160 may determine that the touch means (for example, a finger or a pen) is touched to the touch screen when the touch event is received from the touch screen 110, and may determine that the touch is released when the touch event is not received from the touch screen 110. In addition, when the touch coordinate is changed, the controller 160 may determine that the touch is moved, and may calculate a position variation of the touch and a movement speed of the touch in response to the touch movement. The controller 160 may divide the user gesture based on the touch coordinate, the touch release, the touch movement, a position variation of the touch, and a movement speed of the touch. The user gesture may include a touch, a multi touch, a tap, a double tap, a long tap, a tap & touch, a drag, a flick, a press, a long press, a pinch in, and a pinch out.

In addition, the touch screen 110 may detect a pressure of a touched point by including a pressure sensor. The detected pressure information may be delivered to the controller 160, and may distinguish the touch and a press. A resistive type, a capacitive type, and an electromagnetic induction type may be applied to the touch panel 111.

The display unit 112 may display an image data received from the controller 160 after converting the image data into an analog signal under the control of the controller 160. That is, the display unit 112 may provide various screens according to a use of the portable terminal, for example, a lock screen, a home screen, an application (hereinafter, refers to as an APP) execution screen, a menu screen, a key pad screen, a message writing screen, and an internet screen. The display unit 112 may be formed by a type of a flat panel display unit such as a Liquid Crystal Display (LCD), an Organic Light Emitted Diode (OLED), and an Active Matrix Organic Light Emitted Diode (AMOLED). The display unit 112 may support for an arc trajectory menu display by a landscape mode, an arc trajectory menu display by a portrait mode, and an adaptive screen conversion display according to a change between the landscape mode and the portrait mode according to a rotation direction (or orientation) of the portable terminal 110.

The key input unit 120 may receive number or character information, and may include a plurality of input keys and function keys to set various function. The function keys may include an arrow key, a side key, and a shortcut key that are set to perform the specific function. In addition, the key input unit 120 may generate a key signal related to a user setting and a function control of the portable terminal, and may deliver the key signal to the controller 160. The key signal may be divided into a power on/off signal, a volume control signal, and a screen on/off signal. The controller 160 may control the configurations in response to such key signal. In addition, the key input unit 120 may include a Qwerty keypad, a 3*4 keypad, and a 4*3 keypad that include a plurality of keys. The key input unit 112 may include at least one key (e.g., a soft key, a hard key) for a screen on/off and the portable terminal on/off which is formed in a case side of the portable terminal when the touch panel 112 of the portable terminal 100 is supported as a full touch screen type.

The wireless communication unit 130 may perform a communication of the portable terminal 100. The wireless communication unit 130 may perform the communication such using a voice communication, an image communication, and a data communication by forming a communication channel with a supportable mobile communication network. The wireless communication unit 130 may include a radio frequency transmission unit which performs up conversion and amplification of a frequency of the transmitted signal, and a reception unit which performs low noise amplification and down conversion of a frequency of a received signal. In addition, the wireless communication unit 130 may include a mobile communication module (e.g., 3-Generation mobile communication module, 3.5-Generation mobile communication module, or 4-Generation mobile communication module, etc.), and a digital broadcasting module (e.g., DMB module).

The audio processing unit 140 may transmit an audio data received from the controller 160 to a speaker (SPK) by performing Digital to Analog (DA) conversion, and may deliver the audio data received from a microphone (MIC) to the controller 160 by performing Analog to Digital (AD) conversion. The audio processing unit 140 may be configured with a codec (coder/decoder), and the codec may include a data codec processing a packet data and an audio codec processing an audio signal such using a voice. The audio processing unit 140 may convert the received digital audio signal into the analog signal through the audio codec, and may play the analog signal through the speaker. The audio processing unit 140 may convert the analog audio signal inputted from the microphone into the digital audio signal through the audio codec, and may deliver the digital audio signal to the controller 160.

In particular, the audio processing unit 140 according to an aspect of the present disclosure may support for a function outputting screen layout information and screen operation information according to the user operation using the voice through the speaker when changing the configuration of screen output on the display unit. For example, the audio processing unit 140 may output the screen layout information of the screen that is output on the display unit 112 using a voice through the speaker under the control of the controller 160 when the portable terminal is operated in the special assist mode.

The storage unit 150 may include any suitable type of volatile and/or non-volatile memory, such as Random Access Memory (RAM), a Read-Only Memory (ROM), a solid-state drive (SSD), a hard drive (HD), or a flash memory, for instance. In operation, the storage unit 150 may store various data generated in the portable terminal as well as an Operating System (OS) and the various applications (hereinafter, refers to as an App) of the portable terminal 100. The data may include a data which is generated in the application (hereinafter, refers to as an App) execution of the portable terminal and all types of data that are generated by using the portable terminal or storable by receiving from an external (e.g., an external server, other portable terminal, and a personal computer). The storage unit 150 may store various setting information corresponding to a user interface provided by the portable terminal and a portable terminal function processing.

The storage unit 150 may include the special assist gesture information supported in the special assist mode and a command rule information that is associated in advance with the special assist gesture. The storage unit 150 may store different command rule in response to the special assist gesture according to the setting information. The command rule corresponding to the special assist gesture may be either factory-set or set in response to a user input.

The controller 160 may include any suitable type of processing circuitry, such as a processor (e.g., an ARM-based processor, a MIPS-based processor, an x86-based processor, etc.), a Field-Programmable Gate Array (FPGA), an Application-Specific Integrated Circuit (ASIC), or another electronic circuit(s), for instance. The controller 160 may control the overall operation of the portable terminal and a signal flow between the internal configurations of the portable terminal, and may perform a function processing a data. The controller 160 may control a power supply from a battery to the internal configurations. When the power is supplied, the controller 160 may control a booting procedure of the portable terminal, and may execute various application programs that are stored in a program area in order to execute a function of the portable terminal according to the user setting.

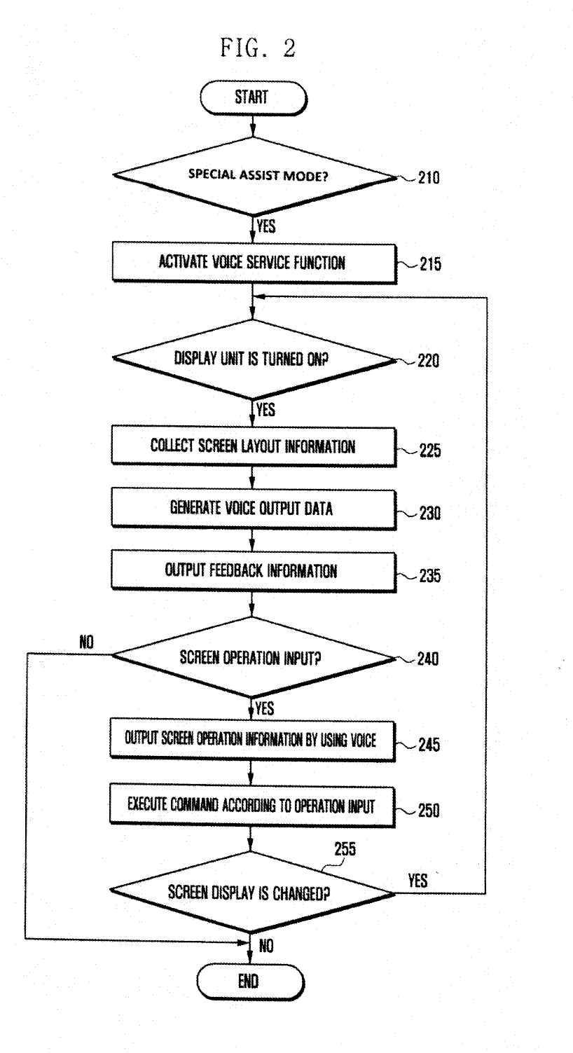

FIG. 2 is a flowchart of an example of a process, according to aspects of the present disclosure. At operation 210, the controller 160 determines whether user input is received for activating a special assist mode of the terminal. If the user input is received, the process proceeds to operation 215.

In the portable terminal 100 according to aspects of the disclosure, icons may be activated differently depending on whether the portable terminal 100 is in the special assist mode. For example, when in normal mode, icons may be activated by a simple touch on the icons. By contrast, when in the special assist mode, a given icon may be activated by first performing a first touch on the given icon and then performing a second touch in another area of the screen that is not occupied by the given icon. Thus, the default touch input that issued to activate icons may be vary depending on the portable terminal's 100 current mode. It will be noted that in some implementations the default inputs for activating icons in the normal mode and/or the special assist mode may be changed according to a user setting or a designer's intention.

At operation 215, the controller 160 activates a voice service function. In some implementations, the voice service function may include a service for outputting audible messages (e.g., voice messages) that provide at least one of (1) screen layout information and (2) feedback information.

At operation 220, the controller 160 determines whether the display unit 112 is in a powered-on state. If the display unit is in the powered-on state, the process proceeds to operation 225.

At operation 225, the controller 160 collects screen layout information corresponding to the screen that is currently presented on the display unit 112. The screen layout information may include position information, feature information, and/or any other suitable type of information that identifies a characteristic of the screen. The position information may include an indication of the position of one or more objects that are displayed in the screen. The feature information may include an indication of the type of one or more objects that are displayed in the screen (e.g., an indication that a call and message icons are displayed), an indication of the type of the screen (e.g., an indication that the terminal's home screen, or a particular application screen, is displayed), and an indication of a portion of the screen that is currently displayed (e.g., an indication that the second page of the terminal's home screen is currently displayed). The screen that is currently presented may include a lock screen, a home screen, an App execution screen, a message writing screen, and or any other suitable type of screen. Any one of the objects may include an icon, a widget, a text input field, and/or any other suitable type of GUI component that is part of the screen.

At operation 230, the controller 160 may generate voice output data based on the collected screen layout information. In some implementations, the portable terminal according to the present disclosure may extract at least portions of the voice output data from a voice service database that is stored in the storage unit 150. The voice output data (or portions thereof) may be extracted based on the collected screen layout information.

In some implementations, the voice output data may include one or more text strings. For example, the voice output data may include the text string “The second page of the Home screen is currently displayed on the touchscreen 110. A call and a message icon are displayed in the bottom of the touch screen”.

In some implementations, the types of information that are included the voice output data may be selectable by the user. For example, the user may specify that any of the following information items be included in the voice output data:
(1) an identification of a screen that is currently displayed (e.g., an indication that the second page of the terminal's home screen is currently displayed),
(2) an indication of the position of a specific icon in the screen (e.g., an indication that a call and a message icons are positioned in the bottom of the screen), and
(3) an indication of the position of a specific widget in the screen (e.g., an indication that a clock widget is displayed in the upper portion of the screen).

At operation 235, the controller 160 may output the voice output information by using a speaker. Doing so may permit users who are visually impaired to understand what information is currently being displayed by the terminal and how this information is arranged on the terminal's display.

At operation 240, the controller 160 may determine whether a screen operation signal is generated in the terminal. In some implementations, the screen operation signal may include a touch signal generated when the touch screen 110 is touched or a key in the key input unit 120 pressed. Additionally or alternatively, in some implementations, the screen operation signal may be generated responsive to a special assist gesture.

At operation 245, the controller 160 may output the feedback information in response to the screen operation signal. The feedback information may be output via an audible message (e.g., a voice message). For example, in some instances, the feedback information may include an identification of an object (e.g., an icon, a menu, etc.) that is touched, an indication that an action is performed in response to the input touch signal, an identification of an action that is performed, and or any other suitable type of information.

In some implementations, outputting the feedback information may include obtaining the feedback information by the controller 160, generating voice output data based on the feedback information, and rendering the voice output data on a speaker.

At operation 250, the controller 160 may execute a command in response to the screen operation signal. Executing the command may include one or more of, launching an application associated with a particular object that is touched, executing code that is associated with the particular object in order to perform a function associated with the object, and/or performing any other suitable type of action.

At operation 255, the controller 160 may determine whether the screen output on the display unit 112 is changed as a result of the command execution. When the screen is changed, the controller 160 may return to operation 220. Otherwise, when the screen display output on the display unit 112 is not changed, the process may terminate.

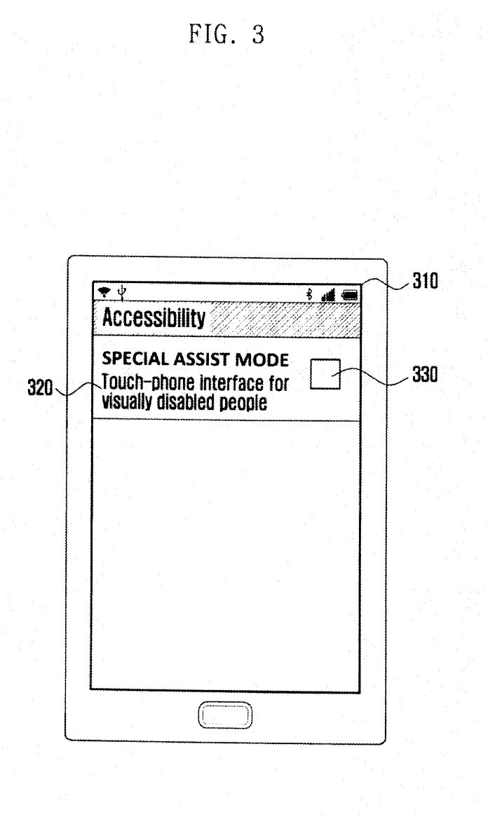

FIG. 3 is a diagram of an example of an interface for activating the special assist mode in a communications terminal. According to this example, the display unit 112 may output a special assist mode setting screen 310 under the control of the controller. The special assist mode setting screen 310 may be a screen which is output when the user opens an accessibility menu in the portable terminal. As illustrated, the special assist mode setting screen 310 may include the information display area 320 and a check box 330 area corresponding to the special assist mode.

In operation, the user may touch the check box 330. Then, the controller 160 may detect that the check box 330 has been selected, and may activate a voice service module by changing the operation mode of the portable terminal to the special assist mode. When the voice information module is activated, the controller may output screen layout information describing the layout of the screen. By way of example, the screen layout information may include the string: “It is a special assist mode setting screen of an accessibility menu. There is a checkbox in the upper-right of the checkbox. Cancel menu is in the bottom right of the screen.” In some implementations, the screen layout information may be output through a speaker.

In some implementations, the portable terminal 100 may permit the user to select specific types of information that the user wishes to be audibly identified (e.g., by using voice) when the portable terminal is in the special assist mode. For example, although not illustrated in FIG. 3, the special assist mode setting screen 310 may include a setting menu that permits the user to select the types of information that are output using audible messages when the terminal is in the special assist mode. For example, and without limitation, the menu may permit the user to select for output one or more of:
(1) information identifying the type of the screen that is currently displayed by the terminal;
(2) touch operation feedback (e.g., dragged voice message indicating that the user just performed a dragging action, touched voice message indicating that the user just performed a touch action),
(3) an indication of a portion of the screen that is currently displayed (e.g., “This is a second page of a home screen.” or “This is a second page of a menu screen”),
(4) screen layout information (e.g., “A text window is located in the upper part of the screen, while a call and message menu icons are located in the bottom of a screen”), and
(5) feedback information identifying an object that is selected (e.g., “An App icon is selected”).

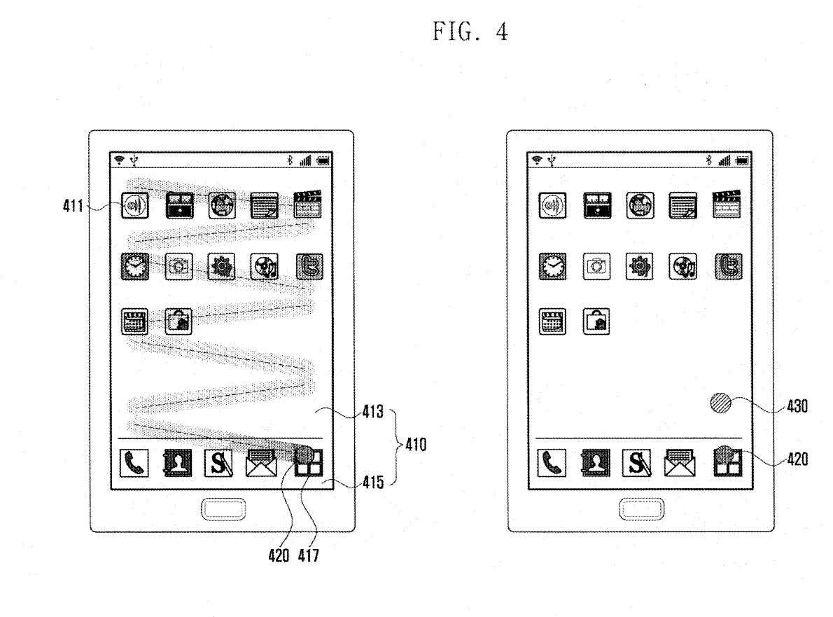

FIG. 4 is a diagram of an example of a user interface according to aspects of the disclosure. Referring to FIG. 4, the display unit 112 may output various screens according to the use of the portable terminal, for example, a lock screen, a home screen, an application execution screen (e.g., an App screen), a menu screen, a keypad screen, a message writing screen, and an internet screen. When the portable terminal is operated in the special assist mode, and the touch screen is turned on, the controller 160 may output an audible message (e.g., a voice message) that provides screen layout information for the screen which is presently output on the display unit 112.

For example, when the touch screen 110 is turned on and a lock screen is output on the display unit 112, the controller may output, through a speaker, a voice message describing the lock screen and a lock release button that is part of the lock screen. The user can hear the voice message, understand where the lock release button is located, and release the lock screen.

As illustrated, a home screen 410 may be output on the display unit 112. The home screen 410 may include a plurality of objects 411 (e.g., an icon, a widget, etc.). The home screen 410 may include a variable display area 413 where different pages can be presented, and a fixed display area 415. The pages presented in the variable display area 413 may be changed by the user. Each of the pages may include any number of objects (e.g., icons). The fixed display area may remain the same as different pages of the home screen are switched. An icon corresponding to a call, contacts, a memo, an email, and a menu function may be disposed in the fixed area 415, however, it is not limited thereto.

In operation, the controller 160 may determine that the screen output on the display unit has been changed from the lock screen to the home screen 410. In response, the controller 160 may output, through a speaker, an audible message (e.g., a voice message) containing screen layout information for the home screen 410. By way of example, the message may include one or more of an identification of the page that is currently displayed, a description of the layout of the page, and an identification of a shape of a gesture. More specifically, in one example, the controller 160 may output the message “Page 1 of the home screen, A call, a message, an email, and a menu button are displayed in the bottom left part of the screen, Please perform a dragging gesture having a zig-zag shape and starting from the upper part of the screen in order to execute a web browser.”

When the message is output, the user may place a first touch 420 (or perform another type of touch gesture) on the screen, and may then perform a dragging gesture having a “zig-zag” shape. The controller 160 may collect the touch position information for the gesture and output voice messages identifying different objects on the screen as those objects are touched while the gesture is being performed. By way of example, when a user movement of the first touch 420 is detected on the “PHONE” icon in the bottom of the home screen, the controller 160 may output a voice message containing the word “PHONE.” Similarly, when the “MENU” icon is touched as a result of the gesture, the controller 160 may output a voice message containing the word “MENU.”

The user may select any given one of the objects (e.g., icons) displayed on the home screen by performing a tap gesture anywhere on the screen after a message corresponding to the given icon is spoken. For example, after the word “MENU” is output, the user may place a second touch (or tap) 430 on the screen in order to select the menu object 417 and/or execute an operation/function corresponding to the menu object 417. In some implementations, the menu object 417 may be activated by the second touch 430 only when the first touch 420 is maintained while the second touch 430 is performed. Additionally or alternatively, the menu object may be activated by the second touch 430 regardless of whether the first touch 420 is maintained while the second touch 430 is performed

After, the second touch is placed, the controller may select the menu object 417 and/or select execute an operation/function corresponding to the menu object 417. The controller 160 may then output a message indicating that the menu object 417 is selected. For example, the controller 160 may use voice to output the message “The menu is selected.” indicating that the menu object 420 is selected through the speaker. This message may help the user recognize that the menu has been selected.

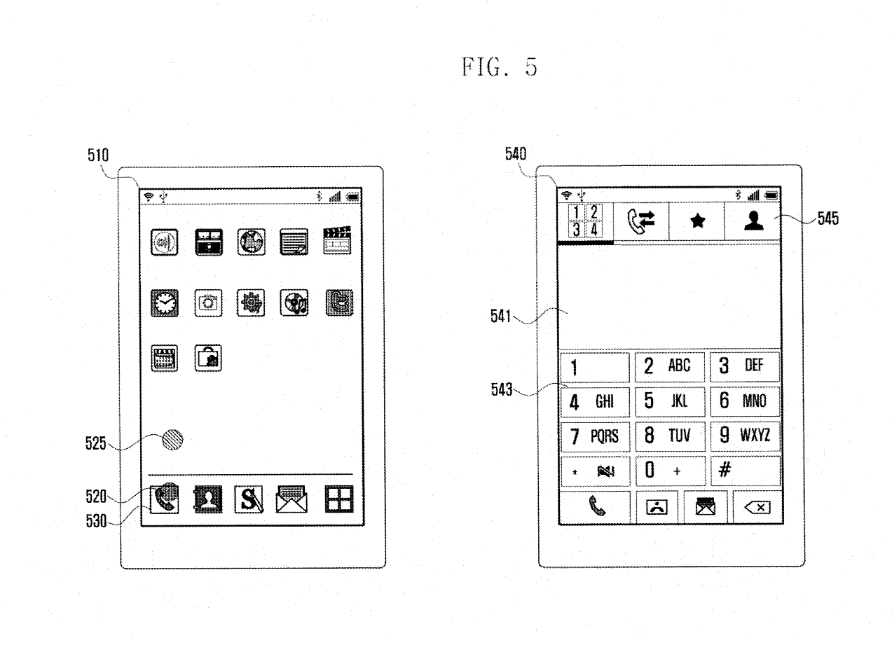

FIG. 5 is a diagram of an example of another user interface according to aspects of the disclosure. As illustrated, the display unit 112 may display a home screen 510 under the control of the controller 160 while operating in the special assist mode. The home screen may provide a plurality of pages that include at least one object. The user may then place a first touch 520 (or perform another type of touch gesture) on a call icon 530. When the first touch 520 is detected, the controller 160 may output voice message containing the word “Call.” Then, the user may place a second touch 525 (or perform another type of touch gesture) anywhere on the screen in order to select the call icon 530 and execute a function/operation corresponding to the call icon 530. Specifically, when the second touch 525 is placed, the controller 160 may display a call screen 540 on the display unit 112. The call screen 540 may include a receiver display area 541 where the other party's telephone number is displayed, a keypad area 543 where the keypad is displayed, and a phone function menu setting area 545. Furthermore, responsive to the screen change, the controller may output a message providing layout information for the new screen. By way of example, the message may include an identification of the new screen, an identification of a portion of the area of the screen that contains a particular object, and an identification of the location of another object. More specifically, in the present example, the controller 160 may output the message “A call screen, A keypad in the bottom of 3/2 area, and A disposition of end button in the left bottom of a keypad) through the speaker.”

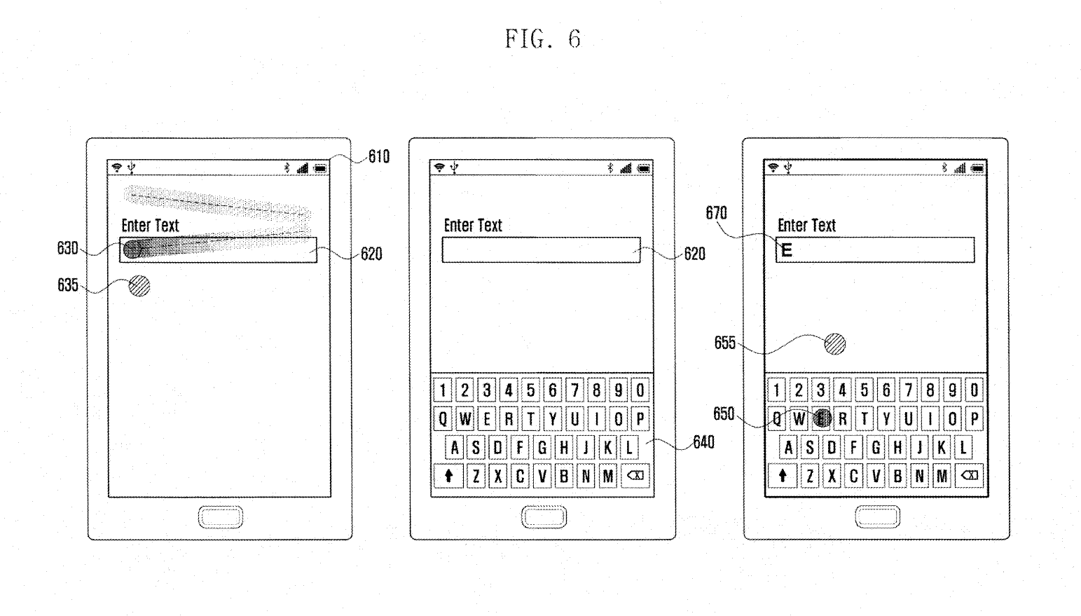

FIG. 6 is a diagram of an example of yet another user interface according to aspects of the disclosure. According to this example, the controller 160 may control the display unit 112 to output a screen 610 where an input object (e.g., a text input window 620) is presented. In addition, when displaying the screen 610, the controller may output an audible message (e.g., voice message) containing layout information for the screen 610.

Next, the controller 160 may detect that a first touch 630 (or another type of touch gesture) is placed on the input object. In response to the first touch 630, the controller 160 may output an audible message (e.g., a voice message) that contains information identifying the type of input which the input object accepts. For example, the controller 160 may output the message “please input text” through the speaker. After the message is output, the user may place a second touch 635 (or another type of touch gesture) on any part of the screen in order to begin entering input.

In response to the second touch 635, the controller 160 may output a keypad window 640 in the bottom of the screen of the display unit 112. In some implementations, the second touch 635 may need to be placed on an a part of the screen that is different from the part of the screen where the first touch 630 is placed, in order for the second to cause the keypad window 640 to be displayed.

After the keypad window 640 is displayed, the controller 160 may further detect that the configuration of the screen 610 has changed, and may output an audible message (e.g., a voice message) indicating the change. In some implementations, the message may provide an updated screen layout information for the screen 610. Additionally or alternatively, in some implementations, the voice message may identify at least one of a type and location of an object that has appeared in the screen 610. More specifically, in one example, the controller 160 may output the message “the keypad window is displayed in the bottom of the screen” through the speaker.

The user may then enter text by performing a touch gesture 650 on the keypad window 640. In instances where the touch gesture is a touch, the controller 160 may output a voice message identifying the key on the keypad that is touched. Additionally or alternatively, in instances where the touch gesture is a drag, the controller may output a series of voice messages, wherein each voice message identifies the key most recently touched by the user while the drag gesture is being performed. For example, when a drag gesture is performed starting at the Q-key and ending at the W-key, the controller may output an audible message indicting that the letter Q is selected when the user's finger (or stylus) is located over the Q-key. Afterwards, as the drag gesture proceeds and the user's finger slides over the W-key, the controller may output another audible message indicating that the user's finger (or stylus) has become located over the W-key.

The user may select the letter that was most recently identified by one of the audible messages by placing a touch 655 (or another gesture) anywhere on the screen 610. In response to the touch 655, the controller 160 may input the letter most recently identified in the text input 620 window. Afterwards, the controller 160 may detect that the configuration of the screen 610 has changed and may output a voice message indicating the change. For example, the controller may output the message “the letter E was input in the text input window”.

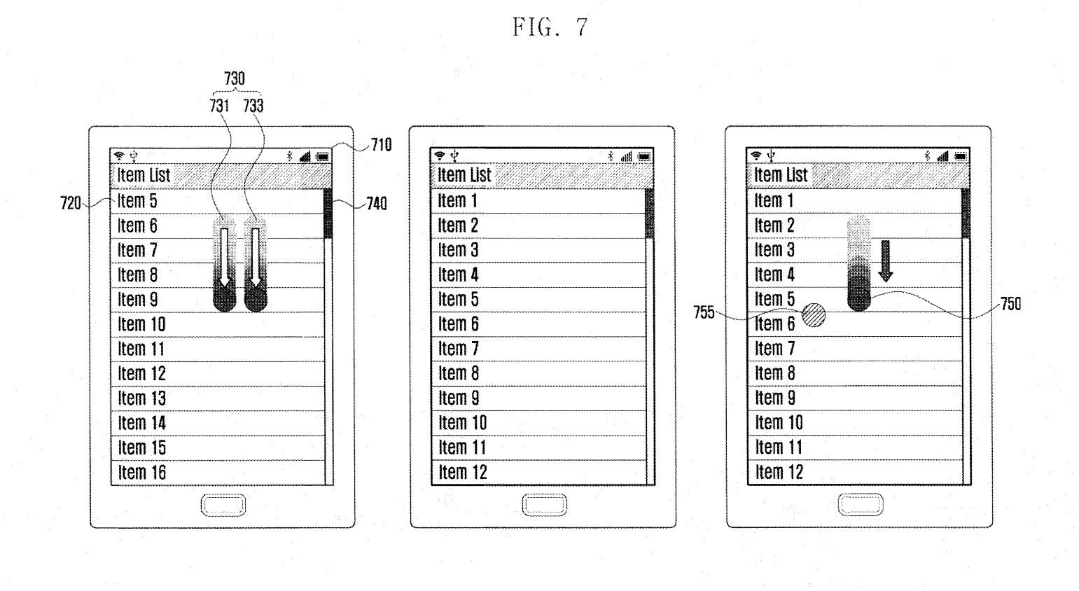

FIG. 7 is a diagram of an example of yet another user interface according to aspects of the disclosure. The display unit 112 may display an item list (e.g. a list of telephone numbers) screen 710. The item list screen 710 may include a scroll bar 740 for scrolling the list. The user may activate the scroll bar 740 by performing a double-touch gesture 750 (or any other type of multi-touch gesture) that includes a first touch 731 and a second touch 733. To perform the double-touch gesture, the user may touch two points of the screen by using a touch contact means (e.g., fingers, styluses, etc.), and then may drag the touch contact means up or down.

The controller 160 may detect the first touch 731 and the second touch 733 on the screen, and may scroll up or down the item list according to the direction of the drag. As the list is being scrolled, the controller 160 may output an audible message (e.g., a voice message) identifying one or more characteristics of the portion of the list that has become displayed after the list is scrolled. The message, in some instances, may identify, as a group, one or more items in the list that become displayed after the list is scrolled. More specifically, in one example, the controller 160 may output the voice message “The first 12 items in the list are being currently displayed.”

Afterwards, the user may perform a dragging gesture 750 (or another type of gesture), as illustrated. While the gesture is being performed, the controller 160 may output a series of audible messages (e.g., voice messages) identifying different items in the list, as those items are touched during the performance of the gesture. To select the item that was most recently identified, the user may perform a touch 755 (or another type of touch gesture) anywhere on the screen.

More specifically, in one example, the user may hear the voice message “item 6” while the gesture 750 is being performed. Afterwards, the user may select item 6 by performing the touch 755 before another message identifying a different list item is output (or before the gesture 750 has progressed onto another item in the list). Finally, in response to the touch 755, the controller 160 may select item 6 and output the voice message “item 6 is selected” through the speaker.

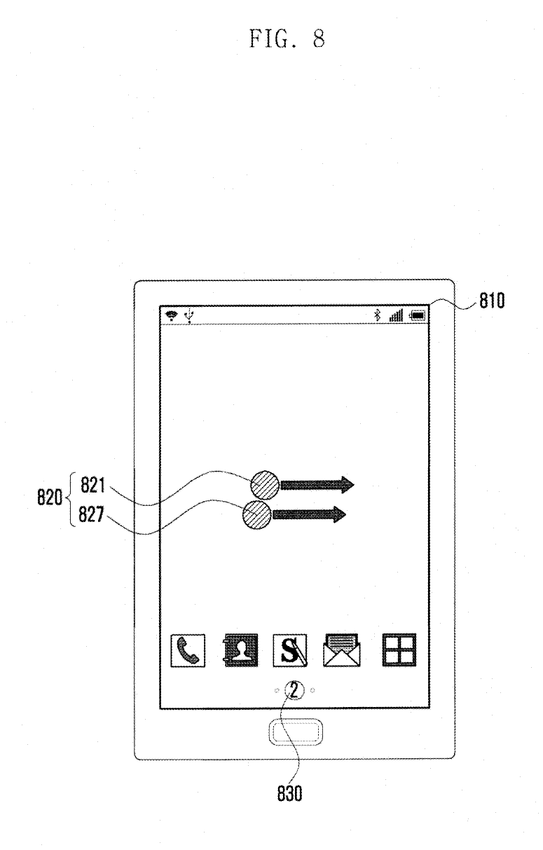

FIG. 8 is a diagram of an example of yet another user interface according to aspects of the disclosure. As illustrated, the display unit 112 may display a home screen 810 under the control of the controller 160.

The home screen 160 may provide a plurality of pages 830. Each page may include one or more objects. To switch between the pages, the user may perform a double-touch gesture 820 (or another type of multi-touch gesture). In this example, the double-touch gesture includes a first touch 821 and a second touch 827. When, the double-touch gesture is performed, the controller 160 may detect the first touch 821 and the second touch 827, and may change the page according to a movement direction of the first touch 821 and the second touch 827. When the page is changed, the controller may output an audible message (e.g., a voice message) identifying the new page.

FIG. 2 is provided as an example. One or more the operations depicted in FIG. 2 may be performed concurrently, in a different order, or altogether omitted. As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “including” and the like) should not be interpreted as limiting the invention to the specific examples; rather, the examples are intended to illustrate only some of many possible aspects.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Although exemplary aspects of the disclosure have been described in detail hereinabove, it should be clearly understood that many variations and modifications of the basic inventive concepts herein taught which may appear to those skilled in the present art will still fall within the spirit and scope of the disclosure, as defined in the appended claims.

What is claimed is:

1. A method comprising:
outputting, by a communications terminal, a first voice message identifying a first screen that is displayed on a touchscreen of the communications terminal; and
executing a command in response to a touch input being received at the touchscreen.

2. The method of claim 1, further comprising:
displaying a second screen in place of the first screen; and
outputting a second voice message identifying the second screen.

3. The method of claim 1, further comprising activating a voice service function when the communications terminal enters a special assist mode.

4. The method of claim 1, further comprising outputting a second voice message indicating that the command is executed.

5. The method of claim 1, wherein outputting the first voice message comprises;
collecting screen layout information for the first screen;
generating a voice output data based on the collected screen layout information; and
rendering the voice output data on a speaker.

6. The method of claim 3 wherein the command is executed in response to the touch input only when the communications terminal is in the special assist mode.

7. The method of claim 1, wherein executing the command comprises:
detecting a first touch that is performed at a first location in the touchscreen;
outputting a second voice message identifying an object that is displayed at the first location;
detecting a second touch while the first touch is maintained;
selecting the object in response to the second touch; and
outputting a third voice message indicating that the object is selected.

8. The method of claim 1, wherein executing the command comprises:
detecting a first touch that is performed at a first location in the touchscreen;
outputting a second voice message identifying an object that is displayed at the first location;
detecting a second touch while the first touch is maintained, wherein the command is executed in response to the second touch, and wherein the command is associated with the object; and
outputting a third voice message indicating that the command is executed.

9. The method of claim 1, wherein executing the command comprises:
detecting a multi-touch gesture while one of a scrollable list or a screen page is displayed on the touchscreen; and
performing an action based on the multi-touch gesture, wherein the action includes one of scrolling the list or replacing the screen page with another screen page.

10. An apparatus comprising:
a touchscreen; and
a controller configured to:
output a first voice message identifying a first screen that is displayed on the touchscreen; and
execute a command in response to a touch input being received at the touchscreen.

11. The apparatus of claim 10, wherein the controller is further configured to:
display a second screen in place of the first screen; and
output a second voice message identifying the second screen.

12. The apparatus of claim 10, wherein the controller is further configured to activate a voice service function when a communications terminal enters a special assist mode.

13. The apparatus of claim 10, wherein the controller is further configured to output a second voice message indicating that the command is executed.

14. The apparatus of claim 10 further comprising a speaker, wherein outputting the first voice message comprises;
collecting screen layout information for the first screen;
generating a voice output data based on the collected screen layout information; and
rendering the voice output data on the speaker.

15. The apparatus of claim 12, wherein the command is executed in response to the touch input only when the communications terminal is in the special assist mode.

16. The apparatus of claim 10, wherein executing the command comprises:
detecting a first touch that is performed at a first location in the touchscreen;
outputting a second voice message identifying an object that is displayed at the first location;
detecting a second touch while the first touch is maintained; and
selecting the object in response to the second touch; and
outputting a third voice message indicating that the object is selected.

17. The apparatus of claim 10, wherein executing the command comprises:
detecting a first touch that is performed at a first location in the touch screen;
outputting a second voice message identifying an object that is displayed at the first location;
detecting a second touch while the first touch is maintained, wherein the command is executed in response to the second touch, and wherein the command is associated with the object; and
outputting a third voice message indicating that the command is executed.

18. The apparatus of claim 10, wherein executing the command comprises:
detecting a multi-touch gesture while one of a scrollable list or a screen page is displayed on the touchscreen; and
performing an action based on the multi-touch gesture, wherein the action includes one of scrolling the list or replacing the screen page with another screen page.
